(19) United States
(12) Patent Application Publication
(10) Pub. No.: US 2016/0263594 A1
(43) Pub. Date: Sep. 15, 2016

(54) FLUID DISPENSING APPARATUS NOZZLE HAVING WEAR-COMPENSATED VALVE SEAT MEMBER, AND RELATED METHODS

(71) Applicant: Nordson Corporation, Westlake, OH (US)

(72) Inventor: William MacIndoe, Exeter, RI (US)

(21) Appl. No.: 15/059,109

(22) Filed: Mar. 2, 2016

Related U.S. Application Data
(60) Provisional application No. 62/131,458, filed on Mar. 11, 2015.

(51) Int. Cl. B05B 1/30; F16K 25/04; F16K 1/14

(52) U.S. Cl. CPC B05B 1/302; F16K 1/14; F16K 25/04

(57) ABSTRACT

A nozzle for use with a fluid dispensing apparatus configured to dispense fluid and including a valve stem, the valve stem having a stem tip and being movable between an open position and a closed position. The nozzle includes a nozzle body and a valve seat member coupled to the nozzle body. The valve seat member includes an outer surface, an inner surface extending in a direction substantially parallel to a direction in which the outer surface extends, and a valve seat extending between the outer surface and the inner surface. The valve seat is configured to contact the stem tip in the closed position. The valve seat has a valve seat surface area, and the valve seat member is configured to maintain the valve seat surface area as substantially constant during wear of the valve seat member caused by repeated contact of the stem tip with the valve seat.

### CROSS REFERENCE TO RELATED APPLICATIONS

This application claims priority to U.S. Provisional Patent Application No. 62/131,458, filed on Mar. 11, 2015, the entire disclosure of which is incorporated herein by reference.

### TECHNICAL FIELD

The present invention relates generally to fluid dispensers, and more particularly, to fluid dispensers having movable valve stems.

### BACKGROUND

The process of manufacturing electronic components, such as light emitting diodes (“LEDs”), generally requires dispensing of various high viscosity fluids. Automated fluid dispensing apparatuses are often employed to meet such demands, particularly in industrial applications requiring a high throughput of electronic components. FIGS. 1A and 1B show partial cross-section views of a dispensing end of a known fluid dispensing apparatus 1. The illustrated portion of the fluid dispensing apparatus 1 includes a fluid chamber member 2 defining a fluid chamber 3, a chamber member support plate 4, a valve stem 5 having a valve stem tip 6 in the form of a ball, a valve seat member 7 defining a valve seat 8, a dispensing nozzle 9, and a nozzle retaining nut 10 threadedly attached to the support plate 4. In use, the valve stem 5 is lifted and lowered so that the stem tip 6 contacts the valve seat 8 and forces fluid downwardly through the valve seat member 7 and the nozzle 9, thereby dispensing the fluid onto a substrate.

In known fluid dispensing apparatuses, such as apparatus 1, the volume of fluid dispensed from the nozzle is a function of the amount of energy that is transferred from the valve stem to the fluid when the stem tip is lowered into contact with the valve seat. The amount of energy transferred from the valve stem to the fluid is a function, in part, of the surface area of the valve seat and the angle of contact between the valve stem and the valve seat. Therefore, varying the surface area of the valve seat and/or the angle of contact varies the amount of energy transferred from the valve stem to the fluid, which in turn varies the volume of fluid dispensed from the nozzle.

Abrasive liquid materials are often dispensed during formation of electronic components, and directly contribute to the wear of internal components of a fluid dispensing apparatus over time. For example, during an encapsulation step of LED manufacture, a mixture of abrasive yellow phosphor and a binder, such as silicone or epoxy, is dispensed onto LED dies. The valve seat of the fluid dispensing apparatus is particularly vulnerable to accelerated wear due to its direct, repeated contact with the abrasive material and the valve stem tip. The valve seat member wears with repeated use of the fluid dispensing apparatus, even when the valve seat member is formed of a hard metallic material.

Valve seat members of known fluid dispensing apparatuses, such as apparatus 1 shown in FIGS. 1A and 1B, are shaped such that the directional wear of the valve seat consequently results in a progressive increase in the surface area of the valve seat. As the valve seat wears with repeated use and thus progressively increases in surface area, the amount of energy transferred from the valve stem to the fluid progressively changes. Thus, the volume of fluid dispensed by the nozzle per stroke of the valve stem also progressively changes, thereby hindering the ability of the fluid dispensing apparatus to dispense with precision and repeatability. Accordingly, the useful life of known valve seat members is undesirably short, thus necessitating frequent replacement. Moreover, known valve seat members are often formed of expensive metallic materials, such as tungsten carbide, making frequent replacement financially burdensome for the user.

During manufacture of electronic components, it is desirable to dispense fluids, including abrasive fluids such as LED encapsulent, with a high degree of precision and repeatability, so as to maintain consistency in the performance characteristics of the resultant electronic components produced through the dispensing operations. It is also desirable to maintain optimal dispensing performance with minimal financial resources being devoted to operational costs, such as for replacement nozzles. Accordingly, there remains a need for improvement in known fluid dispensers to address the shortcomings described above.

### SUMMARY

In accordance with one embodiment, a nozzle for use with a fluid dispensing apparatus configured to dispense fluid is provided. The fluid dispensing apparatus includes a valve stem having a stem tip and is movable between an open position and a closed position. The nozzle includes a nozzle body and a valve seat member coupled to the nozzle body. The valve seat member includes an outer surface, an inner surface extending in a direction substantially parallel to a direction in which the outer surface extends, and a valve seat extending between the outer surface and the inner surface. The valve seat is configured to contact the stem tip in the closed position. The valve seat has a valve seat surface area, and the valve seat member is configured to maintain the valve seat surface area as substantially constant during wear of the valve seat member caused by repeated contact of the stem tip with the valve seat.

In accordance with another embodiment, a fluid dispensing apparatus configured to dispense fluid is provided. The fluid dispensing apparatus includes a dispenser body, a valve stem operatively coupled to the dispenser body, and a nozzle operatively coupled to the dispenser body. The valve stem includes a stem tip and is movable between an open position and a closed position. The nozzle includes a nozzle body and a valve seat member coupled to the nozzle body. The valve seat member includes an outer surface, an inner surface extending in a direction substantially parallel to a direction in which the outer surface extends, and a valve seat extending between the outer surface and the inner surface. The valve seat is configured to contact the stem tip in the closed position. The valve seat has a valve seat surface area, and the valve seat member is configured to maintain the valve seat surface area as substantially constant during wear of the valve seat member caused by repeated contact of the stem tip with the valve seat.

In use, a method of dispensing fluid with a fluid dispensing apparatus is provided. The fluid dispensing apparatus includes a dispenser body, a valve stem operatively coupled to the dispenser body and having a stem tip, and a nozzle operatively coupled to the dispenser body and including a valve seat member having a valve seat. The valve stem is movable between an open position and a closed position. The method includes providing the valve stem in the open position in which the stem tip is spaced from the valve seat and in which the fluid collects in a space between the stem tip and the valve seat. The method further includes moving the valve stem in a direction toward the valve seat to provide the valve stem in the closed position, and forcing the fluid with the stem tip through a passage extending through the valve seat member and the nozzle body to dispense the fluid. The method further includes, while in the closed position, contacting the valve seat with the stem tip, including contacting an upper outer edge of the valve seat member defined by the valve seat and an outer surface of the valve seat member, and contacting a lower inner edge of the valve seat member defined by the valve seat and an inner surface of the valve seat member.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

FIG. 1A is a cross-sectional view of a known fluid dispensing apparatus having a valve stem in an open position.

FIG. 1B is a cross-sectional view of the known fluid dispensing apparatus of FIG. 1 with the valve stem in a closed position.

FIG. 2 is a perspective, partial two-way cross-sectional view of a fluid dispensing apparatus having a nozzle in accordance with an embodiment of the invention.

FIG. 3 is a perspective, cross-sectional view of the nozzle of FIG. 2, showing additional detail of a valve seat member.

FIG. 4A is an enlarged cross-sectional view of the fluid dispensing apparatus of FIG. 2 showing the valve stem in an open position.

FIG. 4B is an enlarged cross-sectional view similar to FIG. 4A showing the valve stem in a closed position.

FIG. 5 is a schematic, cross-sectional view of the nozzle of FIG. 2, showing wear of the valve seat member.

FIG. 6 is a schematic, cross-sectional view of the nozzle of FIG. 2, showing wear of the valve seat member.

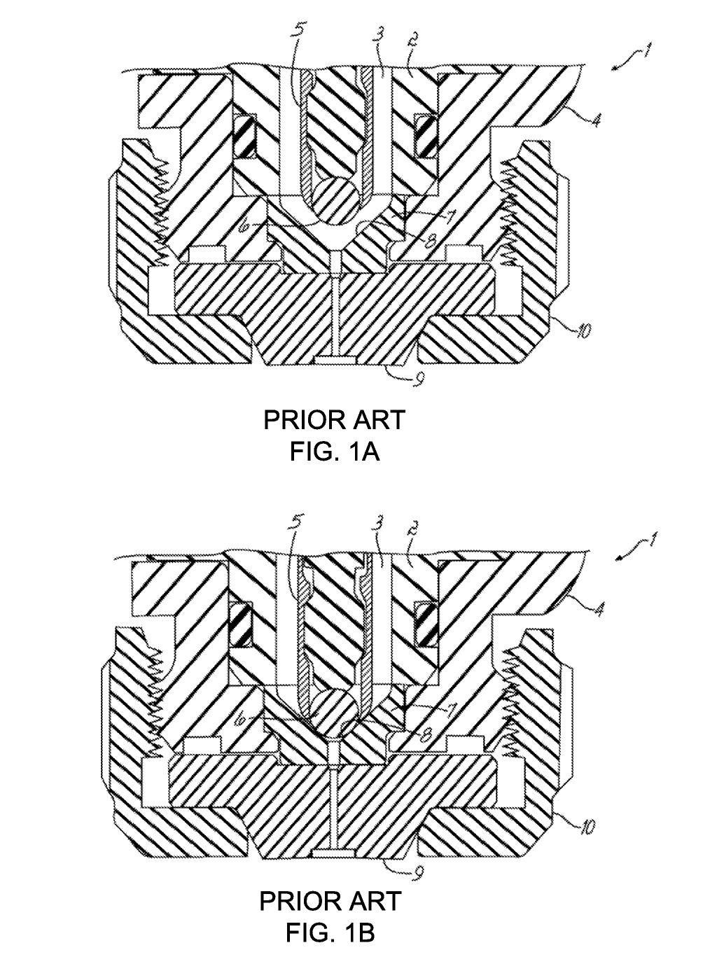

### DETAILED DESCRIPTION

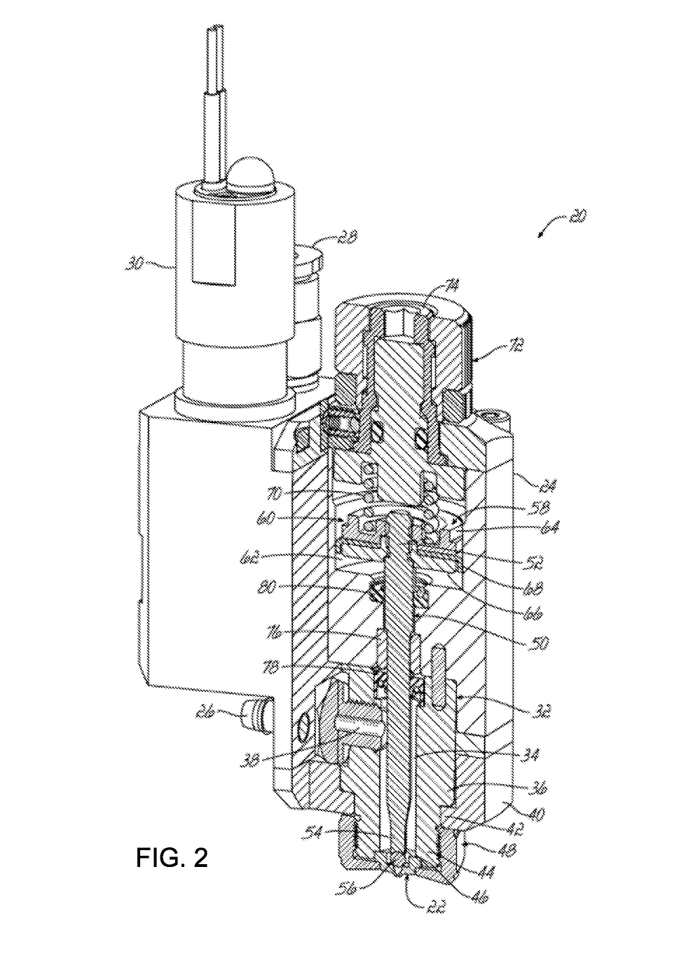

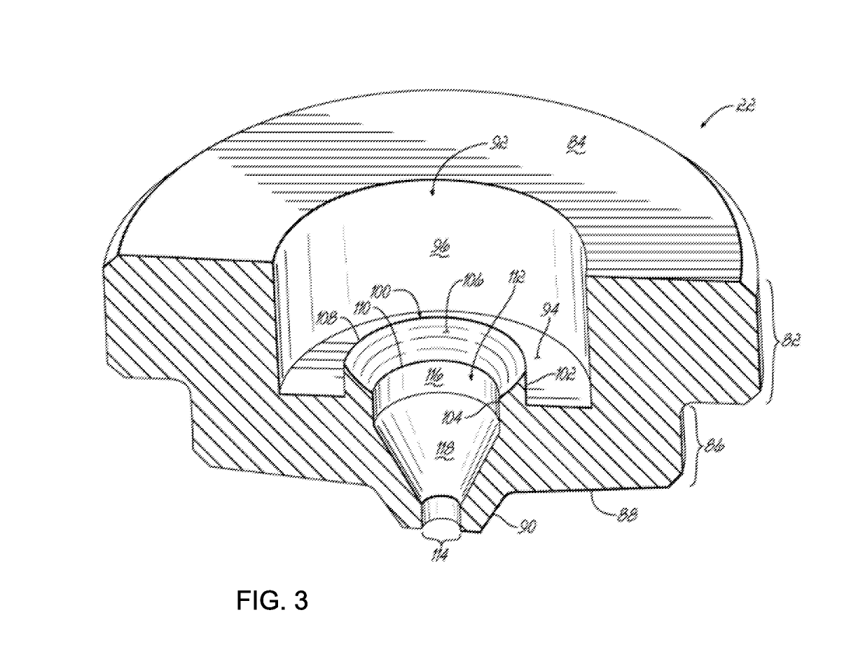

Referring to FIGS. 2-5, a fluid dispensing apparatus 20 has a dispensing nozzle 22 and is operable to dispense viscous liquid material onto a substrate (not shown). In particular, the fluid dispensing apparatus 20 dispenses abrasive liquid materials, such as LED encapsulent or chip underfills containing abrasive particulate, for example. In the embodiment shown, the dispensing apparatus 20 is a non-contact, jetting type dispensing apparatus.

The fluid dispensing apparatus 20 includes a dispenser body 24, a fluid inlet fitting 26 coupled to a lower portion of the dispenser body 24, and an actuating air inlet fitting 28 and a solenoid valve 30 coupled to an upper portion of the dispenser body 24. The fluid inlet fitting 26 receives a supply of liquid material from a liquid material reservoir (not shown), and directs the liquid material inwardly through the dispenser body 24 to be dispensed, as described in greater detail below. The actuating air inlet fitting 28 is adapted to receive a supply of actuating air, and the solenoid valve 30 is operable by a controller (not shown) to selectively direct the actuating air through the dispenser body 24 to actuate internal components of the fluid dispensing apparatus 20 for dispensing the liquid material, as described below.

The fluid dispensing apparatus 20 further includes a fluid chamber member 32 coupled to the dispenser body 24 and defining a cylindrical fluid chamber 34 having a central axis. The fluid chamber member 32 includes an upper chamber member portion 36 having a radially extending bore that receives the fluid inlet fitting 26 therethrough in threaded engagement. Accordingly, a fluid inlet passage 38 defined by the fluid inlet fitting 26 opens to and communicates with the fluid chamber 34 so that liquid material received through the fluid inlet fitting 26 may be directed into the fluid chamber 34.

A chamber member support plate 40 is coupled to the dispenser body 24 and includes a lower annular lip 42 defining an aperture through which a lower chamber member portion 44 extends. The lower chamber member portion 44 includes an annular recess 46 shaped to receive an upper portion of the dispensing nozzle 22 and thereby align the nozzle 22 coaxially with the central axis of the fluid chamber 34. A nozzle retaining nut 48 contacts and supports an upper portion of the nozzle 22, and threadedly engages the lower chamber member portion 44 so as to releasably couple the nozzle 22 to the fluid chamber member 32.

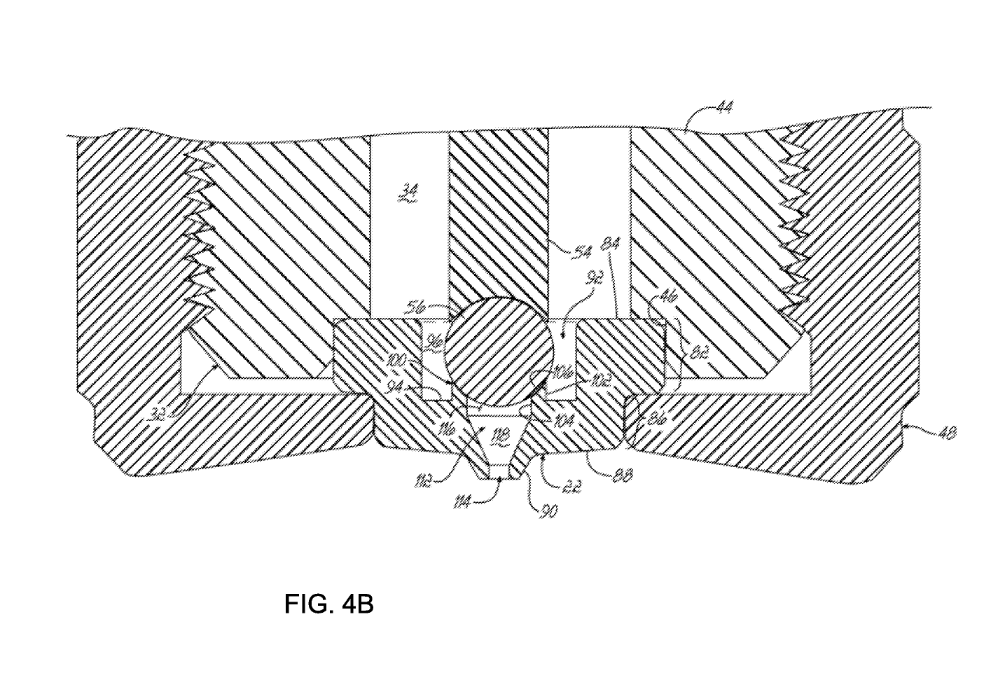

A valve stem 50 extends through the fluid chamber 34 and is movable along the central axis of the fluid chamber 34 between an upward open position shown in FIG. 4A and a downward closed position shown in FIG. 4B. The valve stem 50 includes an upper stem end 52 and a lower stem end 54 defining a valve stem tip 56. In the embodiment shown, the stem tip 56 is in the form of a spherical ball coupled to valve stem 50 at the lower stem end 54. However, in some implementations, the stem tip can have any suitable shape. The stem tip 56 may be formed of a hard metallic material adapted to resist wear, such as tungsten carbide for example.

The upper stem end 52 extends through and is coupled to a piston assembly 58 received within an air cylinder 60 defining an air chamber 62. The air cylinder 60 is defined by an inner surface of the dispenser body 24. The piston assembly 58 includes an upper piston member 64, a lower piston member 66, and a piston seal 68 positioned therebetween and adapted to sealingly contact the air cylinder 60.

A coil compression spring 70 is positioned between the upper piston member 64 and a lower end of a valve stroke adjustment assembly 72. The coil spring 70 exerts a compression spring force on the upper piston member 64 and thereby biases the valve stem 50 toward the downward closed position. The valve stroke adjustment assembly 72 includes a central adjusting screw 74 that may be rotated to selectively adjust an axial distance, referred to as “stroke,” that the valve stem 50 travels between the open position and the closed position.

A valve stem guide 76 encircles a medial portion of the valve stem 50 and maintains the valve stem 50 in coaxial alignment with the fluid chamber 34. A lower stem seal 78 is positioned axially below the valve stem guide 76 and encircles and sealingly contacts the valve stem 50 to create a liquid-tight seal that blocks liquid material from flowing upwardly from the fluid chamber 34 into the air chamber 62. An upper stem seal 80 is positioned axially above the valve stem guide 76 and encircles and sealingly contacts the valve stem 50 to create an air-tight seal that blocks actuating air from flowing downwardly from the air chamber 62 into the fluid chamber 34. In one embodiment, the lower and upper stem seals 78, 80 may be spring-energized to aid in maintaining their respective seals.

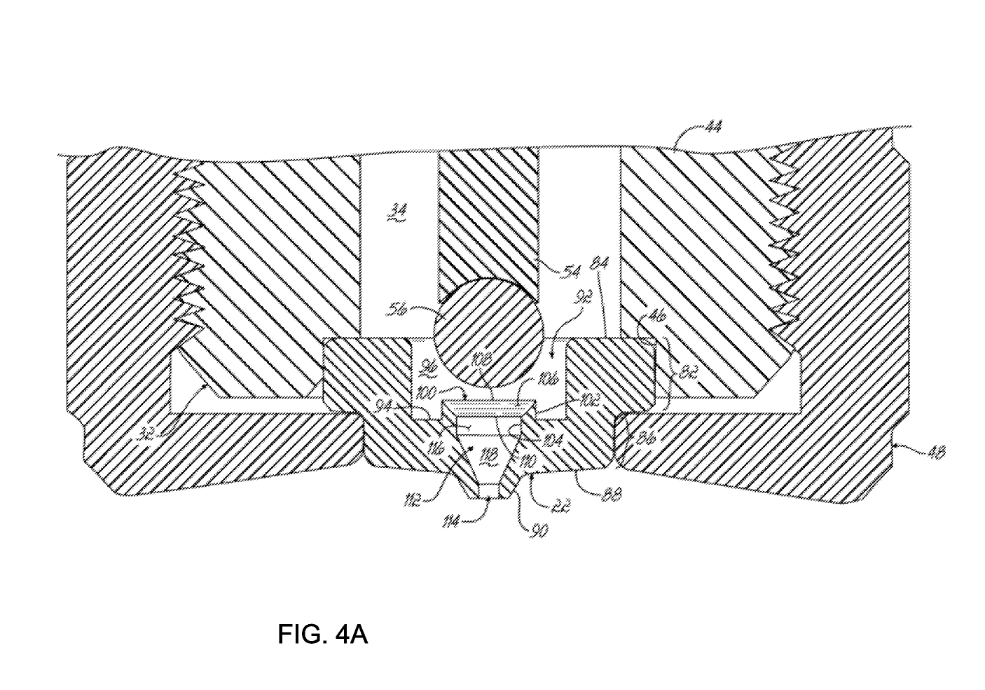

Referring to FIG. 3, the dispensing nozzle 22 is substantially circular in shape and includes a cylindrical upper body portion 82 defining an annular upper surface 84, and a cylindrical lower body portion 86 defining an annular lower surface 88. The lower surface 88 may be angled relative to the upper surface 84 and slope radially toward a central conical tapered portion 90 protruding axially from the lower surface 88. A central blind bore 92 extends through the upper surface 84 and defines an annular base surface 94 and a bore wall 96.

An annular valve seat member 100 protrudes axially from the base surface 94 in a direction toward the upper surface 84 of the nozzle 22. In one embodiment, the valve seat member 100 and the nozzle 22 may be formed integrally as a single unitary piece. The valve seat member 100 includes a cylindrical outer surface 102, a cylindrical inner surface 104, and a valve seat 106 extending between the outer and inner surfaces 102, 104. As shown in FIGS. 2 and 4B, the valve seat 106 is configured to sealingly contact the valve stem tip 56 in the downward closed position. Additionally, the outer cylindrical surface 102, the base surface 94, and the bore wall 96 collectively define an annular pocket. As described in greater detail below, the valve seat member 100 is wear-compensated.

The cylindrical outer and inner surfaces 102, 104 are formed concentrically and extend coaxially along a central axis of the nozzle 22, which is aligned with the central axis of the fluid chamber 34 when the nozzle 22 is mounted to the fluid chamber member 32. The cylindrical outer surface 102 and the valve seat 106 define an upper outer edge 108 of the valve seat member 100. Additionally, the cylindrical inner surface 104 and the valve seat 106 define a lower inner edge 110 of the valve seat member 100. The valve seat 106 extends radially inward and axially downward from the upper outer edge 108 toward the lower inner edge 110. In this regard, the diameter of the cylindrical outer surface 102 defines a maximum outer diameter of the valve seat 106 at the upper outer edge 108. As best shown in FIG. 4B, the cylindrical outer surface 102, and thus the valve seat 106, is formed with an outer diameter that is less than a maximum outer diameter of the valve stem tip 56.

The valve seat 106 may be formed with a concave contour that substantially matches a convex contour of the valve stem tip 56, so as to enhance the sealing engagement between the valve seat 106 and the stem tip 56. Furthermore, in the embodiment shown, the cylindrical outer and inner surfaces 102, 104 of the valve seat member 100 may be formed with suitable axial dimensions such that the valve seat member 100 protrudes from the base surface 94 for an axial distance that permits the valve stem tip 56 to be substantially fully received within the blind bore 92 in the closed position, as best shown in FIG. 4B. In an alternative embodiment (not shown), the bore wall 96 may be angled, such as at an about 45 degree angle relative to the base surface 94. The blind bore 92 may thus assume an inverted cone shape that tapers inward generally towards the valve seat member 100.

The annular valve seat member 100 opens to a dispensing outlet chamber 112 that extends axially toward and communicates with a dispensing outlet passage 114 extending through the conical tapered portion 90 of the nozzle 22. The outlet chamber 112 includes a cylindrical upper chamber portion 116 defined by the cylindrical inner surface 104, and a conical lower chamber portion 118 defined by a tapered inner surface of the nozzle 22. The outlet chamber 112 is configured to funnel liquid material into the outlet passage 114, which then directs the liquid material onto a substrate when the valve stem 50 is moved into the closed position.

Referring to FIGS. 4A and 4B, FIG. 4A shows the valve stem 50 in the upward open position in which the valve stem tip 56 is spaced axially above the valve seat 106. FIG. 4B shows the valve stem 50 in the downward closed position in which the valve stem tip 56 contacts the valve seat 106. As described above, the coil spring 70 biases the valve stem 50 toward the downward closed position. While in the closed position, liquid material received through the fluid inlet fitting 26 is directed through the fluid inlet passage 38 and into the fluid chamber 34. The liquid material surrounds the valve stem 50 and flows into the blind bore 92 of the nozzle 22 to surround the valve stem tip 56 and the valve seat member 100.

To move the valve stem 50 into the upward open position shown in FIG. 4A, the solenoid valve 30 directs actuating air into the air chamber 62, which exerts an upward force on the piston assembly 58 and thereby raises the valve stem 50. In the open position, an axial space is created between the valve stem tip 56 and the valve seat 106, and the liquid material flows into the space. The solenoid valve 30 is then controlled to cease delivery of actuating air into the air chamber 62 and to vent the air from the air chamber 62. Thus, the coil spring 70 forces the valve stem 50 rapidly downward into the closed position in which the stem tip 56 contacts the valve seat 106. Through this rapid downward motion of the valve stem 50, the stem tip 56 forces liquid material downwardly through the dispensing outlet chamber 112 and the dispensing outlet passage 114 so that the liquid material may be dispensed onto a substrate. It will be noted that the valve stem 50 will typically reach its terminal velocity well before the valve stem tip 56 contacts the valve seat 106. This property is found particularly when the liquid material is an LED encapsulent, such as one containing phosphor. The solenoid valve 30 may be selectively controlled by a controller (not shown) to rapidly actuate the valve stem 50 between the closed and open positions for dispensing the liquid material. For example, in one embodiment, the solenoid valve 30 may be controlled to hold the valve stem 50 in the open position for rapid successive periods of approximately 10 milliseconds.

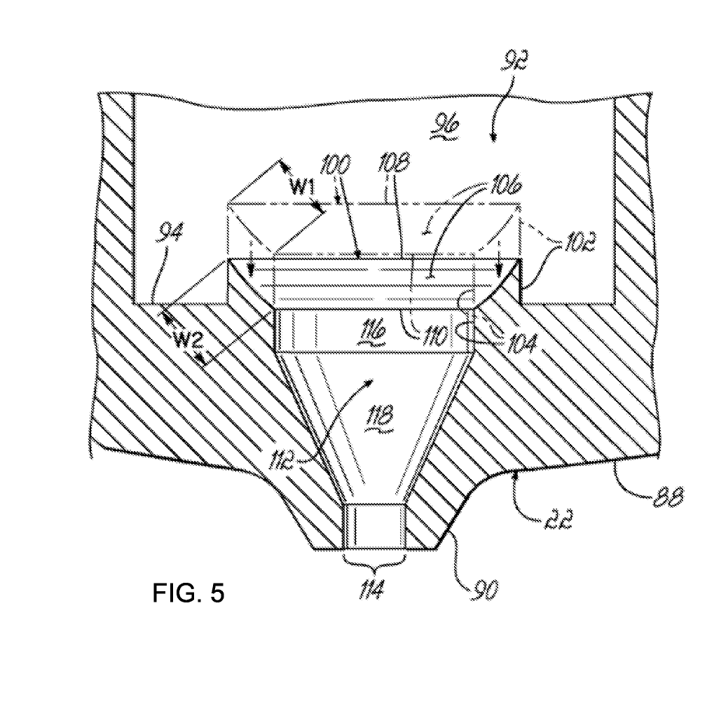

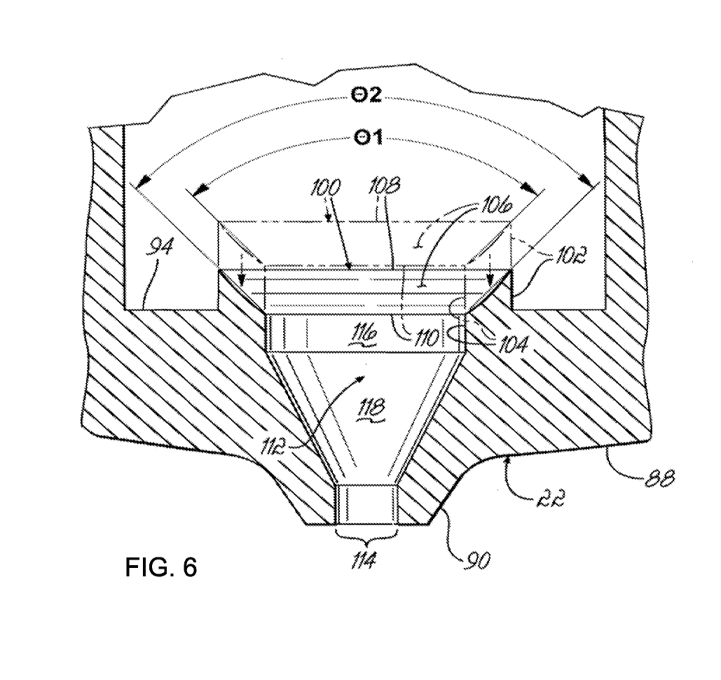

When the valve stem 50 is forced rapidly downward by the spring force into the closed position, the valve stem tip 56 exerts a compressive impact force on the valve seat 106. As described above, the valve stem tip 56 may be formed of a hard metallic material. Additionally, the valve seat member 100 may be formed of a material having a hardness that is less than that of the valve stem tip 56, such that the valve seat member 100 is configured to wear before the valve stem tip 56. For example, the nozzle 22, including the valve seat member 100, may be formed of a plastic such as an ultra high molecular weight polyethylene. Accordingly, repeated impact of the valve seat 106 with the valve stem tip 56 causes wear of the valve seat member 100 in an axial direction toward the dispensing outlet passage 114, as shown schematically in FIG. 5 by directional arrows. As noted above, since the valve stem 50 typically reaches its terminal velocity before the valve stem tip 56 contacts the valve seat 106, the wear of the valve seat member 100 will not have a substantial effect on the energy exerted on the fluid material between the valve stem tip 56 and the valve seat 106 and, thus also on the amount of liquid material dispensed.

Advantageously, the shape of the valve seat member 100 as shown and described herein enables the valve seat 106 to maintain a substantially constant surface area and angle of contact between the valve seat 106 and the valve stem tip 56 as the valve seat member 100 wears axially. In other words, the valve seat member 100 is “wear-compensated,” meaning that the shape of valve seat member 100 compensates for its own wear. As shown in FIG. 5, the valve seat member 100 prior to use has a first axial height and the valve seat 106 has a first width W1 defining a first surface area of the valve seat 106. After repeated use of the fluid dispensing apparatus 20, during which the valve seat 106 is subjected to rapid successive impact forces exerted by the valve stem tip 56, the valve seat member 100 wears axially downward to a second axial height. At this second axial height, the worn valve seat 106 has a second width W2 that is substantially equal to the first width W1. Moreover, the second width W2 defines a second surface area of the worn valve seat 106 that is approximately equal to the first surface area of the unworn valve seat 106, defined by the first width W1.

Further, as seen in FIG. 6, a first angle θ1 is defined by the general angle of intersection between the opposite inner surface areas of the valve seat 106 before the wear from repeated impact forces from the valve stem tip 56. Similarly, a second angle θ2 is defined by the general angle of intersection between the opposite inner surfaces areas of the valve seat 106 after wear from repeated impact forces from the valve stem tip 56. As the valve seat member 100 is worn from repeated impact by the valve stem tip 56, the first angle θ1 and the second angle θ2 remain substantially equal to one another. Therefore, the angle of contact at which the valve stem tip 56 contacts the valve seat 106 is maintained as substantially constant during repeated contact of the valve stem tip 56 with the valve seat 106. This enables the engagement of the valve seat 106 with the valve stem tip 56 to remain constant, and thus also the volume of fluid of material dispensed, regardless of whether the valve seat member 100 is an initial, un-used state or a state of relative wear. To the extent that the inner surface areas of the valve seat 106 include a concave contour, the curvature of the concave contour may similarly remain constant during repeated contact of the valve stem tip 56 with the valve seat 106.

As described above, the volume of liquid material dispensed from the nozzle 22 is a function of the amount of energy transferred from the valve stem 50 to the liquid material when the valve stem tip 56 is lowered into contact with the valve seat 106 in the closed position. Additionally, the amount of energy transferred from the valve stem 50 to the liquid material is a function, in part, of the surface area of the valve seat 106. Accordingly, maintaining a substantially constant surface area and/or angle of contact of the valve seat 106 advantageously enables dispensing of liquid deposits with improved accuracy and repeatability. The wear behavior of the valve seat member 100 described above is enabled by the coaxial and concentric relationship of the cylindrical outer and inner surfaces 102, 104, such that the two surfaces 102, 104 extend in mutually parallel directions.

The useful life of the valve seat member 100 may be the period of use during which the width, and thus the surface area, of the valve seat 106 is maintained as substantially constant relative to the original surface area of the valve seat 106 prior to use. In this regard, the cylindrical outer and inner surfaces 102, 104 may be suitably formed with respective axial dimensions that dictate the duration of the period during which the width of the valve seat 106 is maintained. For example, in one embodiment, the valve seat member 100 may be formed such that the surface area of the valve seat 106 is substantially maintained until the upper outer edge 108 of the valve seat 106 is worn substantially flush with the base surface 94.

At the end of the useful life of the valve seat member 100, the nozzle 22 may be removed from the fluid dispensing apparatus 20 and replaced with a new nozzle 22 having an unworn valve seat member 100. As described above, the nozzle 22, including valve seat member 100, may be formed of a plastic material using injection molding methods. Accordingly, the nozzle 22 may be inexpensively formed while still presenting a useful life of adequate duration, thereby advantageously minimizing operational costs for the user.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A nozzle for use with a fluid dispensing apparatus configured to dispense fluid and including a valve stem, the valve stem having a stem tip and being movable between an open position and a closed position, the nozzle comprising:
a nozzle body; and
a valve seat member coupled to the nozzle body and including an outer surface, an inner surface extending in a direction substantially parallel to a direction in which the outer surface extends, and a valve seat extending between the outer surface and the inner surface, the valve seat being configured to contact the stem tip in the closed position,
wherein the valve seat has a valve seat surface area, and the valve seat member is configured to maintain the valve seat surface area as substantially constant during wear of the valve seat member caused by repeated contact of the stem tip with the valve seat.

2. The nozzle of claim 1, wherein the valve seat further has an angle of contact at which the stem tip contacts the valve seat, and the valve seat member is configured to maintain the angle of contact as substantially constant during wear of the valve seat member caused by repeated contact of the stem tip with the valve seat.

3. The nozzle of claim 1, wherein the valve seat member is annular and the outer surface includes a cylindrical outer surface and the inner surface includes a cylindrical inner surface extending coaxially with the cylindrical outer surface.

4. The nozzle of claim 1, wherein the valve seat and the outer surface of the valve seat member define an upper outer edge of the valve seat member, and the valve seat and the inner surface of the valve seat member define a lower inner edge of the valve seat member, the upper outer edge and the lower inner edge being configured to contact the stem tip in the closed position.

5. The nozzle of claim 1, further comprising:
a bore extending through an upper surface of the nozzle body and having a base surface, wherein the valve seat member protrudes from the base surface in a direction toward the upper surface.

6. The nozzle of claim 5, wherein the passage includes a chamber at least partially defined by the valve seat member.

7. The nozzle of claim 1, further comprising:
a passage extending through the nozzle body and the valve seat member, the passage configured to direct the fluid therethrough for dispensing.

8. The nozzle of claim 7, wherein the chamber includes a cylindrical chamber portion and a conical chamber portion extending therefrom, the cylindrical chamber portion being defined by the inner surface of the valve seat member.

9. The nozzle of claim 1, wherein the valve seat includes a contoured surface.

10. The nozzle of claim 9, wherein the valve seat member is configured to maintain a curvature of the contoured surface as substantially constant during wear of the valve seat member caused by repeated contact of the stem tip with the valve seat.

11. The nozzle of claim 1, wherein the valve seat member is formed of a plastic.

12. A fluid dispensing apparatus configured to dispense fluid, comprising:
a dispenser body;
a valve stem operatively coupled to the dispenser body and having a stem tip, the valve stem being movable between an open position and a closed position; and
a nozzle operatively coupled to the dispenser body, the nozzle including:
a nozzle body; and
a valve seat member coupled to the nozzle body and including an outer surface, an inner surface extending in a direction substantially parallel to a direction in which the outer surface extends, and a valve seat extending between the outer surface and the inner surface, the valve seat being configured to contact the stem tip in the closed position,
wherein the valve seat has a valve seat surface area, and the valve seat member is configured to maintain the valve seat surface area as substantially constant during wear of the valve seat member caused by repeated contact of the stem tip with the valve seat.

13. The fluid dispensing apparatus of claim 12, wherein the valve seat further has an angle of contact at which the stem tip contacts the valve seat, and the valve seat member is configured to maintain the angle of contact as substantially constant during wear of the valve seat member caused by repeated contact of the stem tip with the valve seat.

14. The fluid dispensing apparatus of claim 12, wherein the valve seat member is annular and the outer surface has a cylindrical outer surface and the inner surface includes a cylindrical inner surface extending coaxially with the cylindrical outer surface.

15. The fluid dispensing apparatus of claim 14, wherein the valve seat is formed with a maximum outer diameter that is not greater than a maximum outer diameter of the stem tip.

16. The fluid dispensing apparatus of claim 12, wherein the valve seat and the outer surface of the valve seat member define an upper outer edge of the valve seat member, and the valve seat and the inner surface of the valve seat member define a lower inner edge of the valve seat member, the upper outer edge and the lower inner edge being configured to contact the stem tip in the closed position.

17. The fluid dispensing apparatus of claim 12, further comprising:
a bore extending through an upper surface of the nozzle body and having a base surface, wherein the valve seat member protrudes from the base surface in a direction toward the upper surface.

18. The fluid dispensing apparatus of claim 12, further comprising:
a passage extending through the nozzle body and the valve seat member, the passage configured to direct the fluid therethrough for dispensing.

19. The fluid dispensing apparatus of claim 18, wherein the passage includes a chamber at least partially defined by the valve seat member.

20. The fluid dispensing apparatus of claim 19, wherein the chamber includes a cylindrical chamber portion and a conical chamber portion extending therefrom, the cylindrical chamber portion being defined by the inner surface of the valve seat member.

21. The fluid dispensing apparatus of claim 12, wherein the valve seat member is formed of a plastic.

22. The fluid dispensing apparatus of claim 12, wherein the valve seat includes a contoured surface.

23. The fluid dispensing apparatus of claim 22, wherein the valve seat member is configured to maintain a curvature of the contoured surface as substantially constant during wear of the valve seat member caused by repeated contact of the stem tip with the valve seat.

24. A method of dispensing fluid with a fluid dispensing apparatus including a dispenser body, a valve stem operatively coupled to the dispenser body and having a stem tip, the valve stem movable between an open position and a closed position, and a nozzle operatively coupled to the dispenser body and including a valve seat member having a valve seat, the method comprising:
providing the valve stem in the open position in which the stem tip is spaced from the valve seat and in which the fluid collects in a space between the stem tip and the valve seat;
moving the valve stem in a direction toward the valve seat to provide the valve stem in the closed position, and forcing the fluid with the stem tip through a passage extending through the valve seat member and the nozzle body to dispense the fluid; and
while in the closed position, contacting the valve seat with the stem tip, including contacting an upper outer edge of the valve seat member defined by the valve seat and an outer surface of the valve seat member, and contacting a lower inner edge of the valve seat member defined by the valve seat and an inner surface of the valve seat member.

25. The method of claim 24, wherein the upper outer edge and the lower inner edge of the valve seat member define a valve seat surface area, and contacting the valve seat with the stem tip in the closed position includes maintaining the valve seat surface area as substantially constant during wear of the valve seat member caused by repeated contact of the stem tip with the valve seat.

26. The method of claim 24, wherein the valve seat has an angle of contact at which the stem tip contacts the valve seat, and the valve seat member is configured to maintain the angle of contact as substantially constant during wear of the valve seat member caused by repeated contact of the stem tip with the valve seat.
